(19) United States
(12) Patent Application Publication
(10) Pub. No.: US 2008/0227491 A1
(43) Pub. Date: Sep. 18, 2008

(54) Communication unit selecting apparatus, communication unit selecting system, exchange unit and communication unit selecting program

(75) Inventors: Hiroyuki Oonuma, Tokyo (JP); Masachika Fuchigami, Saitama (JP); Masaki Matsudaira, Yokohama (JP); Yukihiro Morita, Tokorozawa (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO. LTD., Tokyo (JP)

(21) Appl. No.: 12/007,426

(22) Filed: Jan. 10, 2008

(30) Foreign Application Priority Data
Mar. 12, 2007 (JP) JP2007-061675

(51) Int. Cl. H04M 1/00

(52) U.S. Cl. 455/557

(57) ABSTRACT

An available communication unit extracting section which when user status information concerning the status of first user and second user is provided from an external unit during communication between a communication unit used by a first user and a communication unit used by a second user, extracts an available communication unit which is available for communication between the first user and the second user from preliminarily prepared candidates based on user status information; and a communication unit selecting section for selecting the available communication unit as a communication unit suitable for communication between the first user and the second user.

### CROSS-REFERENCES TO RELATED APPLICATIONS

The present invention contains subject matter related to Japanese Patent Application JP 2007-061675 filed in the Japan Patent Office on Mar. 12, 2007, the entire contents of which being incorporated herein by reference.

### BACKGROUND OF THE INVENTION

1. Field of the Invention

The present invention relates to a communication unit selecting apparatus, communication unit selecting system, exchange unit and communication unit selecting program and can be applied to, for example, reexamination of a communication unit during communication between communication units.

2. Description of the Related Art

In recent years, a service in which a fixed-line phone and a mobile phone are integrated such as fixed mobile convergence (FMC) has appeared, so that the mobile phone and the fixed-line phone can be used separately under a single telephone number corresponding to a situation. For example, such a service of, when a call is made to a specified single number corresponding to a call transfer server, transferring that call to any one of soft phone, mobile phone and fixed-line phone or all of them has become available. In this case, if presence information of a receiver is controlled in the received call transfer server, for example, control corresponding to a situation can be performed, such as transferring that call to a mobile phone if he or she is out.

For the reason, systems using presence information which publicizes his or her own status such as during a meeting or away from office or home has been proposed in message system described in Japanese Patent Application Laid-Open No. 2003-271531, presence service communication system described in Japanese Patent Application Laid-Open No. 2003-186775 and status communication system described in Japanese Patent Application Laid-Open No. 2003-274440.

### SUMMARY OF THE INVENTION

However, the respective systems described in the above patent documents do not correspond to a change in the status during communication and after communication is established, providing a support using presence information has not been accomplished.

Recently, due to prevalence of Internet phone, a style in which he or she not only informs other people of a message but also talks on the phone for a long time while working another thing has been prevailing. In this case, there is such a difference in his or her behavior during a call between the mobile phone and the Internet phone, that if a headset is connected to a personal computer through a wire, he or she cannot make a call unless he or she stays near the personal computer. Additionally, he or she cannot move during a call when the headset is connected to the personal computer and therefore, it is difficult to do other work at the same time. Thus, sometimes the mobile phone which allows he or she to move during a call is effective depending on his or her situation. Because communication charge of the Internet is cheaper, some people prefer to use the Internet phone rather than the mobile phone. Therefore, although the mobile phone is more convenient when he or she is moving, he or she might prefer to use the Internet phone after he or she arrives at home while talking because the Internet phone is cheaper. As a result, system is required to cope with the situation appropriately by analyzing a situation between persons talking to each other.

Accordingly, a communication unit selecting apparatus, communication unit selecting system, exchange unit and communication unit selecting program capable of selecting an appropriate communication unit corresponding to the status of user even during communication have been demanded.

According to an embodiment of the present invention, there is provided a communication unit selecting apparatus comprising: (1) an available communication unit extracting means which when user status information concerning the status of first user and second user is provided from outside during communication between a first communication unit used by the first user and a second communication unit used by the second user, extracts an available communication unit which is usable for communication between the first user and the second user from preliminarily prepared candidates based on the user status information; and (2) a communication unit selecting means for selecting the extracted available communication unit as a communication unit suitable for communication between the first user and the second user.

Furthermore, according to another embodiment of the present invention, there is provided a communication unit selecting system comprising: (1) the communication unit selecting apparatus of the first embodiment further including a communication unit recommending means for recommending a communication unit selected by the communication unit selecting means to at least one of the first user and the second user; and (2) a recommended unit notifying means which when other communication unit suitable for communication between the first user and the second user is recommended by the communication unit selecting apparatus, notifies the recommended other communication unit to user of the communication unit.

Furthermore, according to another embodiment of the present invention, there is provided an exchange unit including the communication unit selecting apparatus according to the first embodiment of the invention.

Furthermore, according to a another embodiment of the present invention, there is provided (0) a communication unit selecting program for selecting a communication unit for use in communication between the first user and the second user, the communication unit selecting program making a computer function as (1) an available communication unit extracting means which when user status information concerning the status of first user and second user is provided from outside during communication between a first communication unit used by the first user and a second communication unit used by the second user, extracts an available communication unit which is usable for communication between the first user and the second user from preliminarily prepared candidates based on the user status information; and (2) a communication unit selecting means for selecting the extracted available communication unit as a communication unit suitable for communication between the first user and the second user.

According to the embodiments of the present invention described above, an appropriate communication unit can be selected corresponding to the status of user even when communication is being done.

### BRIEF DESCRIPTION OF THE DRAWINGS

FIG. 1 is a block diagram showing the entire configuration of a communication unit selecting system according to a first embodiment;

FIG. 2 is an explanation diagram showing the system configuration for call transfer in communication based on a conventional FMC;

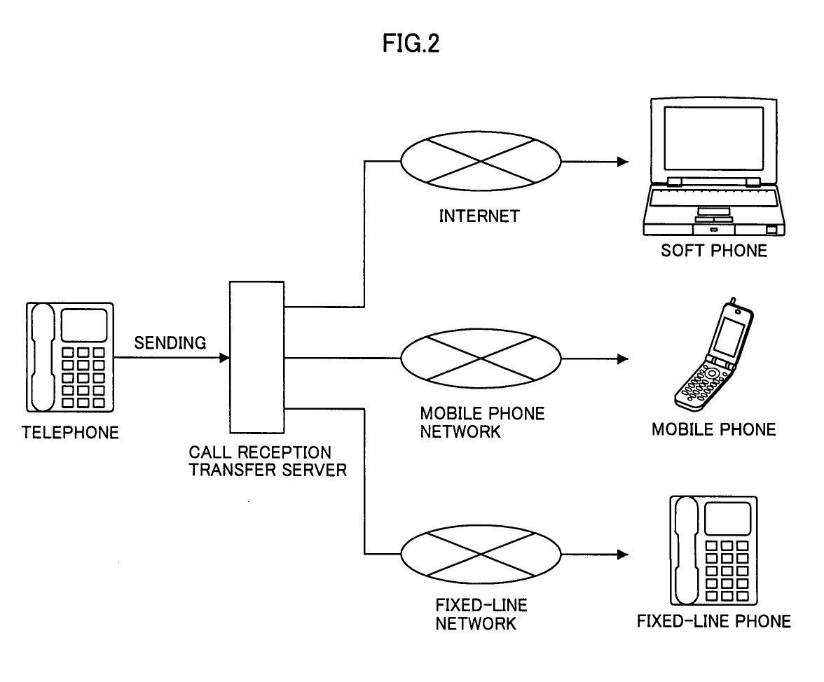

FIG. 3 is an explanatory diagram showing the configuration of information to be stored in a permission information storage portion according to the first embodiment;

FIG. 4 is an explanatory diagram showing the configuration of information stored in a communication information temporary storage portion according to the first embodiment;

FIG. 5 is an explanatory diagram showing the configuration of information stored in a terminal information storage portion according to the first embodiment;

FIG. 6 is a flowchart showing an operation of updating information in the communication information temporary storage portion by the communication unit selecting apparatus of the first embodiment;

FIG. 7 is a flowchart showing an operation of selecting an optimum communication unit and recommending a user by the communication unit selecting apparatus of the first embodiment;

FIG. 8 is an explanatory diagram for explaining the content of information stored in the permission information storage portion of the communication unit selecting apparatus used by user B according to the first embodiment;

FIG. 9 is an explanatory diagram for explaining the content of information stored in the terminal information storage portion of the communication unit selecting apparatus used by user B according to the first embodiment;

FIG. 10 is an explanatory diagram showing the content of information stored in the communication information temporary storage portion of the communication unit selecting apparatus used by user A before communication is started, according to the first embodiment;

FIG. 11 is an explanatory diagram showing the content of information stored in the communication information temporary storage portion of the communication unit selecting apparatus used by user B before communication is started, according to the first embodiment;

FIG. 12 is an explanatory diagram showing the content of information stored in the communication information temporary storage portion of the communication unit selecting apparatus used by user A just after communication is started according to the first embodiment;

FIG. 13 is an explanatory diagram showing the content of information stored in the communication information temporary storage portion of the communication unit selecting apparatus used by user B just after communication is started according to the first embodiment;

FIG. 14 is an explanatory diagram showing the content of information stored in the communication information temporary storage portion of the communication unit selecting apparatus used by user A after user A arrived at home according to the first embodiment;

FIG. 15 is an explanatory diagram showing the content of information stored in the communication information temporary storage portion of the communication unit selecting apparatus used by user B after user A arrived at home according to the first embodiment;

FIG. 16 is a block diagram showing the entire configuration of the communication unit selecting system according to a second embodiment; and

FIG. 17 is an explanatory diagram showing the configuration of information stored in a behavior storage portion according to the second embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and configuration are denoted with the same reference numerals, and repeated explanation of these structural elements is omitted.

### (A) First Embodiment

Hereinafter, a communication unit selecting apparatus, communication unit selecting system and communication unit selecting program of the first embodiment of the present invention will be described in detail with reference to the drawings.

### (A-1) Configuration of the First Embodiment

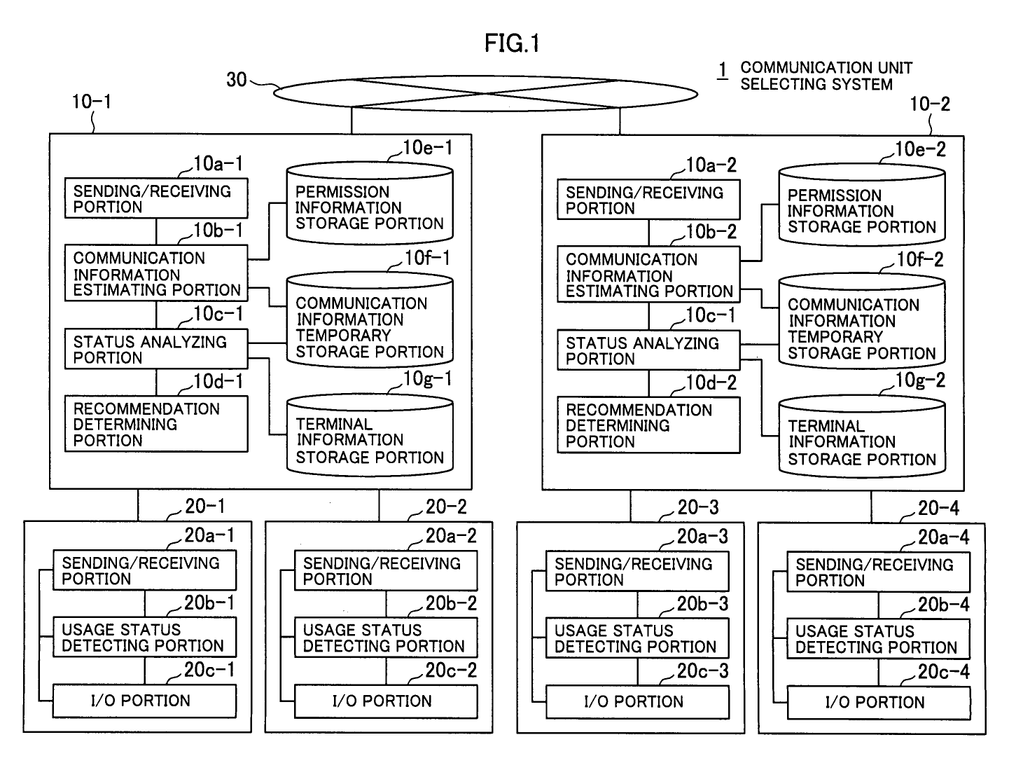

FIG. 1 is a block diagram showing the entire configuration of a communication means selecting system of this embodiment.

The communication unit selecting system 1 includes a plurality of communication unit selecting apparatus 10 (10-1, 10-2, . . . ), a plurality of communication units 20 (20-1, 20-2, 20-3, 20-4, . . . ) and network 30.

The communication unit 20 (20-1, 20-2, 20-3, 20-4, . . . ) is a communication unit used by a user of the communication unit selecting apparatus 10 (10-1, 10-2, . . . ). The communication unit 20 is accommodated in any of the communication unit selecting apparatus 10. For example, all the communication units used by a single user may be accommodated in a single communication unit selecting apparatus 10.

The communication unit 20 is a terminal capable of audio communication, including, for example, a mobile phone, fixed-line phone, and soft phone on personal computer. The communication unit 20 has a sending/receiving portion 20a, a usage status detecting portion 20b and an I/O portion 20c. The communication unit 20 has other configuration necessary for audio communication, such as a microphone, speaker and interface for connecting to telephone line.

The sending/receiving portion 20a is an interface with the communication unit selecting apparatus 10, which exchanges data with the communication unit selecting apparatus 10. Communication between the sending/receiving portion 20a and the sending/receiving portion 10a is not restricted to Internet or LAN but may be by infrared ray communication or peer-to-peer communication and is not restricted to any particular one.

The I/O portion 20c is an interface for user to input or output information. For example, if the communication unit 20 is a soft phone installed in the personal computer, an input device such as a keyboard and an output device such as a display unit fall under this. The I/O portion 20c gives information to the usage status detecting portion 20b if the I/O portion 20c is being used by user. For example, if the communication unit 20 is a soft phone, user gives information about whether or not input is being carried out using the input device such as a keyboard to the usage status detecting portion 20b.

The usage status detecting portion 20b detects a usage status of a given unit and sends the information to the communication unit selecting apparatus 10 through the sending/receiving portion 20a. For example, if the given unit is a mobile telephone terminal capable of acquiring position information through global positioning system (GPS), the usage status detecting portion 20b may acquire latitude/longitude information and give it to the communication unit selecting apparatus 10. If the given unit is communicating with other communication unit 20, the usage status detecting portion 20b may acquire identification information about telephone number and the like from a mating communication unit 20 and give it to the communication unit selecting apparatus 10. If the given unit is a soft phone, the usage status detecting portion 20b may acquire information about whether or not input is being carried out by user using an input device such as a keyboard from the I/O portion 20c and if the input is executed, determine that the given unit is being used by user and then give the information to the communication unit selecting apparatus 10.

The communication unit selecting apparatus 10 (10-1, 10-2, . . . ) accommodates a plurality of the communication units 20 and selects plural communication units 20 optimum for communication corresponding to a status of communication and notifies user. The communication unit selecting apparatus 10 is constructed by installing a communication unit selecting program of the embodiment into an information processing unit such as a personal computer.

The communication unit selecting unit 10 (10-1, 10-2, . . . ) includes the sending/receiving portions 10a (10a-1, 10a-2, . . . ), communication information estimating portions 10b (10b-1, 10b-2, . . . ), status analyzing portions 10c (10c-1, 10c-2, . . . ), recommendation determining portions 10d (10d-1, 10d-2, . . . ), permission information storage portions 10e (10e-1, 10e-2, . . . ), communication information temporary storage portions 10f (10f-1, 10f-2, . . . ) and terminal information storage portions 10g (10g-1, 10g-2, . . . ).

The permission information storage portion 10e stores information for determining whether or not the communication unit 20 should be recommended depending on which a mating party is. That is, the permission information storage portion 10e stores a telephone number of a mating party like a telephone book together with information about whether or not information should be publicized depending on each mating party.

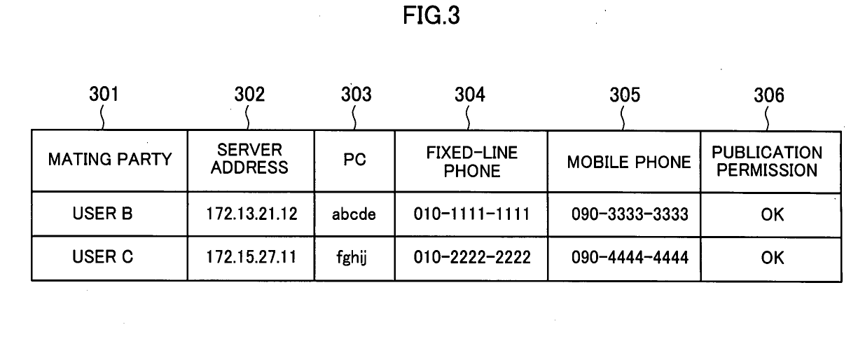

FIG. 3 is an explanatory diagram showing the configuration of information to be stored in the permission information storage portion 10e. The permission information storage portion 10e includes information about a mating party 301, a server address 302, a PC 303, a fixed-line phone 304, a mobile phone 305 and publication permission 306. The mating party 301 is information for distinguishing a mating party and stores information about name or the like. The server address 302 stores identification information of the communication unit selecting apparatus 10 used by the mating party, for example, IP address or the like. If the mating party uses a soft phone on a personal computer as a communication unit 20, the PC 303 stores identification information of that soft phone, for example, ID information of the soft phone. The fixed-line phone 304, if the mating party uses the fixed-line phone, stores information about that telephone number. Likewise, the mobile phone 305 stores a telephone number or the like as the identification information. The publication permission 306 stores information about whether or not information about communication information should be publicized to a corresponding mating party. For example, when information is publicized to the corresponding mating party, “OK” is stored and when no information is publicized, “NG” is stored.

For example, in case where the mating party 301 is “user B” in FIG. 3, the server address 302 is “172.13.21.12”, the PC 303 is “abcde”, the fixed-line phone 304 is “0010-1111-1111”, the mobile phone 305 is “090-3333-3333” and the publication permission 306 is “OK”. Although the PC 303, the fixed-line phone 304, and the mobile phone 305 are stored in the permission information storage portion 10e as the kind of the communication unit 20 used by the mating party, this embodiment is not restricted to these but information about other kind of the terminal such as personal handy-phone system (PHS) may be stored. If the mating party uses plural communication units 20 of the same kind, information about all the communication units 20 used by the mating party may be stored and the kind and quantity of the communication units 20 are not limited to any particular ones.

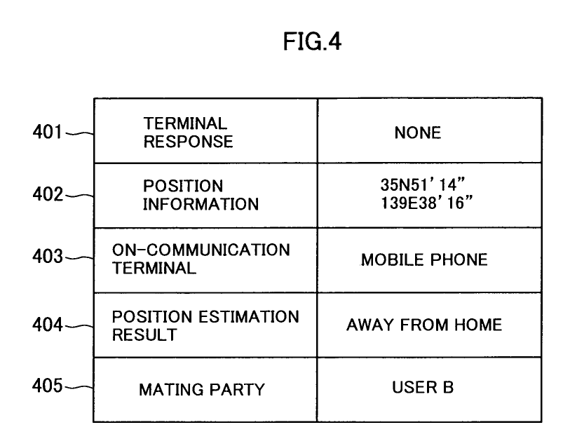

FIG. 4 is an explanatory diagram showing the configuration of information stored in the communication information temporary storage portion 10f. The communication information temporary storage portion 10f includes information about terminal response 401, position information 402, on-communication terminal 403, position estimation result 404 and mating party 405.

The terminal response 401 stores information about which communication unit 20 is operated by user of the given unit, for example, if user of the given unit is operating the mobile phone, information about “mobile phone” is stored. If the user of the given unit is not operating any communication unit 20, information “NONE” may be stored in the terminal response 401. The position information 402 stores information about a current position of the user of the given unit, and for example, latitude/longitude information may be stored like “35N51′ 14″ 139E38′ 16″ (35°51′ 14″ in north latitude, 139°38′ 16″ in east longitude). The on-communication terminal 403 stores information about which communication unit 20 is being used when the user of the given unit is talking. For example, if the user of the given unit is talking through the mobile phone, information “mobile phone” is stored. The position estimation result 404 stores an estimation result of a position of the user of the given unit. For example, information “away from home”, “at home” may be stored. The mating party 405 stores identification information of the mating party, for example, with whom the user of the given unit is talking.

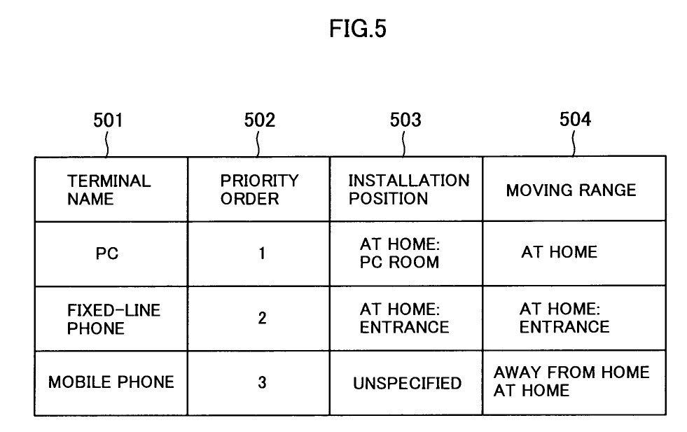

FIG. 5 is an explanatory diagram showing the configuration of information stored in the terminal information storage portion 10g. The terminal information storage portion 10g stores information about the communication unit 20 for use by the user of the given unit, priority order upon communication and a moving range upon using of the communication unit 20. The terminal information storage portion 10g includes terminal name 501, priority order 502, installation position 503, and moving range 504. The terminal name 501 stores identification information of the communication unit 20. The priority order 502 stores the priority order of the communication unit 20 corresponding to the terminal name 501. For example, the communication unit 20 having the highest priority order may be supplied with information “1”, and terminals having following priority order may be supplied with information such as “2”, “3”, “4” . . . .

The moving range 504 stores information about a range in which the corresponding communication unit 20 can move. For example, any one of “away from home”, “at home”, “unspecified” and position information expressed by detailing the indoor condition beginning with “at home: “or a combination thereof may be used. For example, if the information stored in the moving range 504 is “at home: entrance”, it is permitted to express that the corresponding communication unit 20 can be used only at the entrance at home. If the information stored in the moving range 504 is “at home”, it is permitted to express that the corresponding communication unit 20 is available at every place at home. The installation position 503 stores information showing a position where the communication unit 20 corresponding to the terminal name 501 is installed. For example, if a PC as the communication unit 20 is installed in a PC room at home, information “at home: PC room” may be stored at the installation position 503 in which the terminal name 501 is “PC”.

Regarding information in which the terminal name is “PC” as shown in FIG. 5, if the installation position 503 is “at home: PC room” and the moving range 504 is “at home”, it indicates that the soft phone of the PC which is the communication unit 20 exists in the PC room and is available at every place at home. This is an example that the soft phone of the PC can be used with a headset connected by radio. If the headset is connected to the PC by wire, the installation position 503 is replaced with information such as “at home: PC room” because the moving range is limited. Further, as for information in which the terminal name 501 is “fixed-line phone” in FIG. 5, the installation position 503 is “at home: entrance” and the moving range 504 is “at home: entrance”. Consequently, in this case, it indicates that the fixed-line phone is available only at the entrance indoor. On the other hand, as for information in which the terminal name 501 is “mobile phone”, the installation position 503 is “unspecified” and the moving range 504 is “away from home, at home”. Thus, in this case, it indicates that the mobile phone is available regardless of whether at home or away from home.

The sending/receiving portion 10a is an interface with other unit and communicates with other communication unit selecting apparatus 10 or the communication unit 20 through the network 30.

The communication information estimating portion 10b estimates a communication status of user of the given unit and stores the estimated information in the communication information temporary storage portion 10f based on the information provided from the communication unit 20 through the sending/receiving portion 10a. For example, if position information of the communication unit 20 is provided by the communication unit 20, that information may be stored in the position information 402 of the communication information temporary storage portion 10f. If information saying that the communication unit 20 is being used by user of the given unit is provided from the communication unit 20, information of the communication unit 20 corresponding to the terminal response 401 may be stored. If identification information such as a telephone number is provided from the communication unit 20 which user of the given unit uses for communication, values of the mating party 405 and the on-communication terminal 403 may be updated by specifying a mating party from correspondence relation among the provided identification information, identification information (PC 303, fixed-line phone 304, mobile phone 305) stored in the permission information storage portion 10e and information of the mating party 301.

If communication in the communication unit 20 is ended, the communication information estimating portion 10b may update information about the on-communication terminal 403 and the mating party 405 in the communication information temporary storage portion 10f to a clear status (for example, initializing by memorizing a value of X or the like). As for detection of termination of communication in the communication unit 20, for example, when the usage status detecting portion 20b in the communication unit 20 detects an end of communication and that information is provided through the sending/receiving portion 20a and the sending/receiving portion 10a, it may be determined that communication in the communication unit 20 is ended.

The communication information estimating portion 10b estimates a current position of user of the given unit and updates information of the position estimation result 404 in the communication information temporary storage portion 10f. For example, the communication information estimating portion 10b may register the latitude/longitude information of his or her home preliminarily and if the current position coincides with it, determine that he or she is “at home” and otherwise, determine that he or she is “away from home”. If the current position of user of the given unit is “at home”, the communication information estimating portion 10b may estimate a current position in home further and update information of the position estimation result 404 in the communication information temporary storage portion 10f. As another estimation method, it is permissible to specify the communication unit 20 which is operated by user of the given unit based on information of the terminal response 401 in the communication information temporary storage portion 10f, then specify an installation position of the specified communication unit 20 from the installation position 503 of the terminal information storage portion 10g and estimate that the installation position is a current position of user of the given unit.

The status analyzing portion 10c analyzes communication status of user of the given unit based on information acquired form the communication unit selecting apparatus 10 used by a mating party of the user of the given unit or information stored in the communication information temporary storage portion 10f.

The status analyzing portion 10c extracts a communication unit 20 which user of a given unit can use currently (hereinafter, referred to as available communication unit). The communication unit 20 which exists at a current position of user of the given unit may be used as the available communication unit and the communication unit 20 in which a current position of user of a given unit indicated by the position estimation result 404 stored in the communication information temporary storage portion 10f and information of the moving range 504 stored in the terminal information storage portion 10g-1 coincide each other may be extracted as the available communication unit. Further, the status analyzing portion 10c provides information of the extracted available communication unit to the communication unit selecting apparatus 10 of the mating party through the sending/receiving portion 10a and the network 30.

The status analyzing portion 10c may compare the available communication unit in the given unit with information of the available communication unit in the communication unit selecting apparatus of the mating party when the user of the given unit is talking and extract the communication unit 20 of a coincident kind and give that information to the recommendation determining portion 10d. For example, if the available communication unit in the given unit is “PC” or “mobile phone” and the available communication unit which is a mating party is “PC”, only the “PC” is extracted as the coincident communication unit 20.

The recommendation determining portion 10d selects a communication unit 20 optimum for communication based on an analysis result given by the status analyzing portion 10c and recommends it to the user of the given unit. As for a method of selecting the optimum communication unit 20, for example, the recommendation determining portion 10d may select a communication unit 20 having the highest priority, that is, a communication unit 20 having the smallest value in the priority order 502 in the terminal information storage portion 10g as an optimum communication unit from the available communication units given by the status analyzing portion 10c. For example, if information of the available communication terminal given by the status analyzing portion 10c is “PC” and “mobile phone”, and as for information stored in the terminal information storage portion 10g, as shown in FIG. 5, the priority order 502 of the “PC” as the terminal name 501 is “1” and the priority order 502 of the “mobile phone” as the terminal name 501 is “2”, the priority of the “PC” is higher than the “mobile phone” and then the “PC” is selected as a communication unit 20 optimum for communication.

As for a method for the recommendation determining portion 10d to recommend the communication unit 20 optimum for communication to the user of a given unit, if the user of the given unit uses soft phone as the communication unit 20, it may be notified to the communication unit 20 (terminal of soft phone) using information transmitting means such as mail, voice and when call is made to a selected communication unit 20 (terminal of soft phone), if user of the given unit picks up a receiver, communication with the communication unit 20 of a mating party may be automatically established. As long as user of the given unit can communicate with a mating party using the communication unit 20 selected by the recommendation determining portion 10d, any method may be adopted.

### (A-2) Operation of the First Embodiment

Next, the operation of communication unit selection in the communication unit selecting system of the first embodiment constructed as described above will be described.

### (A-2-1) Operation for Information Update in the Communication Information Temporary Storage Portion

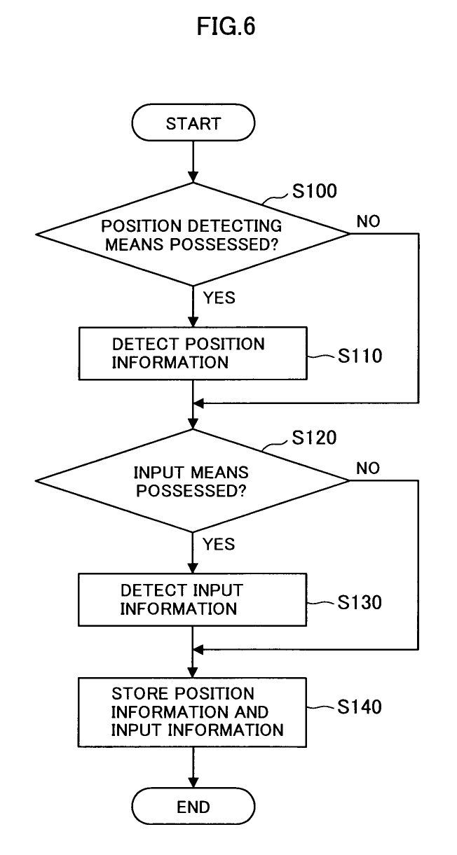

FIG. 6 is a flow chart showing an operation of communication unit 20's detecting the usage status of a given unit and providing that information to the communication unit selecting apparatus so as to update information of the communication information temporary storage portion 10f. Here, user A is user of the communication unit selecting apparatus 10-1, and assumed to use a mobile phone having position detecting means by GPS as the communication unit 20-1. User A is assumed to be away from home.

First, step S100 will be described. In this step S100, whether or not the given unit has any position detecting means is determined with the usage status detecting portion 20b-1 of the communication unit 20-1.

If in step S100, it is determined that the communication unit 20-1 has the position information detecting means, the procedure proceeds to step S110. In step 110, the position information is detected by the position information detecting means. Here, because the communication unit 20-1 has the position detecting means based on the GPS, it is assumed that detection of the position information is carried out by that means and consequently information saying “35N51′ 14″, 139E38′ 16″” (35°51′ 14″ in north latitude, 139°38′ 16″ in east longitude) has been detected. On the other hand, if it is determined that the communication unit 20-1 has no position information detecting means as a result of the determination in step S100, the procedure proceeds to step S120.

Next, step S120 will be described. In this step S120, whether or not the given unit has any input means such as a keyboard and mouse as the I/O portion 20c-1 is determined by the usage status detecting portion 20b-1 of the communication unit 20c-1.

If it is determined that the communication unit 20-1 has an input means as a result of the determination in step S120, the procedure proceeds to step S130. In step S130, information about whether or not input operation is carried out by the input means is detected. Here, because the communication unit 20-1 is a mobile phone, for example, if it has an input means like push buttons, it is determined that it has the input means and then it is assumed that information about whether or not the input operation is carried out by the means is detected and that it is detected that no input operation has been carried out. On the other hand, if it is determined that the communication unit 20-1 has no input means as a result of the determination in step S120, the procedure proceeds to step S140.

Next, step S140 will be described. In this step S140, information detected in the above steps S110-S130 is provided to the communication information estimating portion 10b-1 from the usage status detecting portion 20b-1 through the sending/receiving portion 20a-1 and the sending/receiving portion 10a-1 of the communication unit selecting apparatus 10-1. Then, when the information is provided from the communication unit 20-1, information in the communication information temporary storage portion 10f-1 is updated by the communication information estimating portion 10b-1. Here, as for information stored in the communication information temporary storage portion 10f-1, the position information 402 is updated by the communication information estimating portion 10b-1 based on information detected in the above step S110 to “35N51′14″, 139E38′ 16″ (35 51′ 14″ in north latitude, 139°38′ 16″ in east longitude) and the terminal response 401 is updated to “NONE” based on information detected by the above step S130.

The operations of steps S100-S140 shown in FIG. 6 are carried out by the communication unit 20 (20-1, 20-2, 20-3, 20-4, . . . ) and the communication unit selecting apparatus 10 (10-1, 10-2, . . . ) at every predetermined time interval.

### (A-2-2) Operation of Selecting a Communication Unit

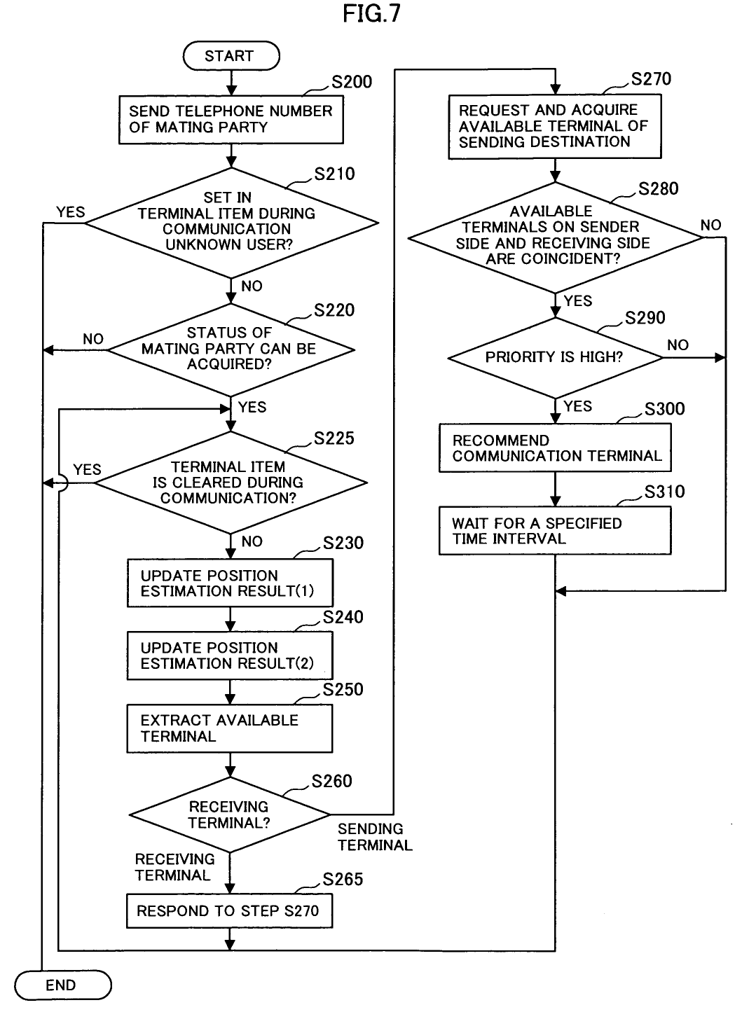

FIG. 7 is a flow chart showing an operation of communication unit selecting apparatus 10's selecting an optimum communication unit 20 and recommending it to user. In the meantime, the communication unit 20 and the communication unit selecting apparatus 10 on a sending side and the communication unit 20 and the communication unit selecting apparatus 10 on a receiving side are carried out in the same way until the procedure is branched at step S260.

Here, user A is user of the communication unit selecting apparatus 10-1 and user A uses the communication unit 20-1 and the communication unit 20-2 as the communication unit 20. The communication unit 20-1 is a mobile phone and the communication unit 20-2 is a soft phone. On the other hand, user B is user of the communication unit selecting apparatus 10-2 and user B uses the communication unit 20-3 and the communication unit 20-4 as the communication unit 20. The communication unit 20-3 is a mobile phone and the communication unit 20-4 is a soft phone. User A of the communication unit selecting apparatus 10-1 uses the communication unit 20-1 (mobile phone) to make a call to the communication unit 20-3 (mobile phone) of user B using the communication unit selecting apparatus 10-2.

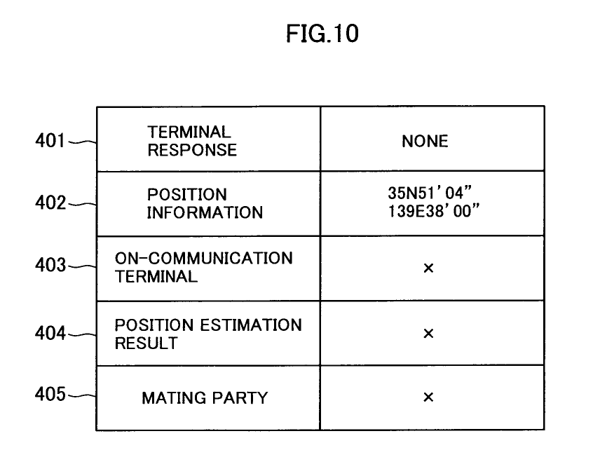

It is assumed that information of mating party 301: “user B”, server address 302: “172.13.21.12”, PC303: “abcde”, fixed-line phone 304: “010-1111-1111”, mobile phone 305: “090-3333-3333”, publication permission 306: “OK” is stored in the permission information storage portion 10e-1 of the communication unit selecting apparatus 10-1 used by user A as shown in FIG. 3. Further, it is assumed that information of (terminal name 501: “PC”, priority order 502: “1”, installation position 503: “at home: PC room”, moving range 504: “at home”) and (terminal name 501: “mobile phone”, priority order 502: “3”, installation position 503: “unspecified”, moving range 504: “away from home, at home”) in the terminal information storage portion 10g-1 as shown in FIG. 5. It is assumed that as shown in FIG. 10, information of terminal name 401: “none”, position information 402: “35N51′ 04″, 139E38′ 00″”, on-communication terminal 403: “X (cleared status)”, position estimation result 404: “X (cleared status)”, mating party 405: “X(cleared status)” in the communication information temporary storage portion 10f-1 prior to start of communication.

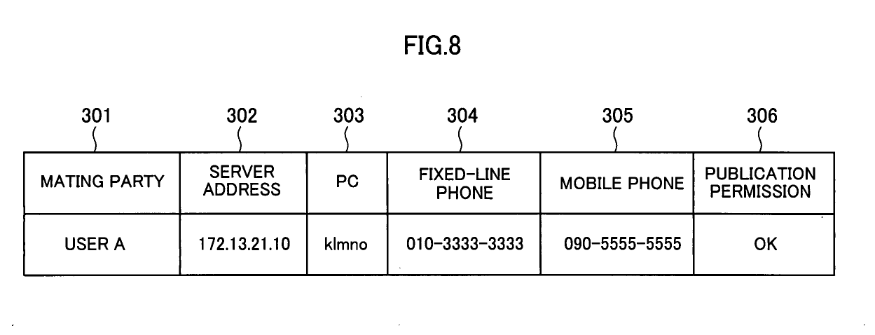

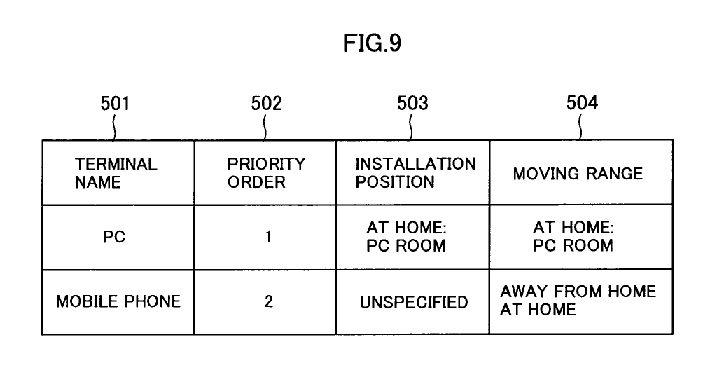

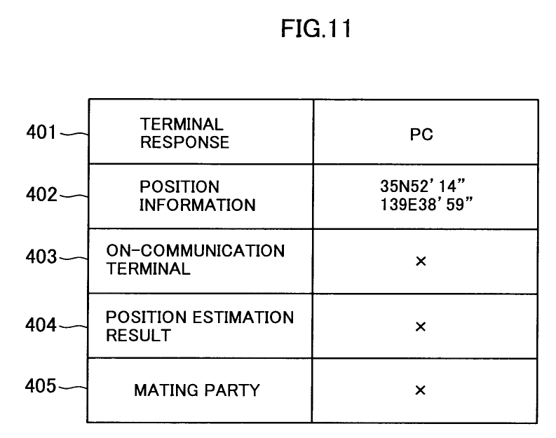

It is assumed that information of mating party 301: “user A”, server address 302: “172.13.21.10”, PC 303: “klmno”, fixed-line phone 304: “010-3333-3333”, mobile phone 305: “090-5555-5555” and publication permission 306: “OK” in the permission information storage portion 10e-2 of the communication unit selecting apparatus 10-2 used by user B as shown in FIG. 8. Further, it is assumed that information of (terminal name 501:“PC”, priority order 502: “1”, installation position 503: “at home: PC room”, moving range 504: “at home: PC room”) and (terminal name 501: “mobile phone”, priority order 502: “2”, installation position 503: “unspecified”, moving range 504: “away from home, at home”) in the terminal information storage portion 10g-1 as shown in FIG. 9. It is assumed that as shown in FIG. 11, information of terminal response 401: “PC”, position information 402: “35N52′ 14″, 139E38′ 59″”, on-communication terminal 403: “X (cleared status)”, position estimation result 404: “X(cleared status)”, mating party 405: “X(cleared status)” in the communication information temporary storage portion 10f-2 prior to start of communication.

First, step S200 will be described. In this step S200, after communication is established between the communication unit 20-1 (user A) and the communication unit 20-3 (user B), a telephone number is detected as identification information of a sending destination (communication unit 20-3) by the usage status detecting portion 20b-1 on the sending party side (communication unit 20-1). That information is provided (sent) to the communication information estimating portion 10b-1 through the sending/receiving portion 20a-1 and the sending/receiving portion 10a-1 of the communication unit selecting apparatus 10-1. On the communication unit 20-3 on the receiving side also, a telephone number is detected as identification information of a sender(communication unit 20-1) by the usage status detecting portion 20b-3 and that information is given to the communication information estimating portion 10b-2 through the sending/receiving portion 20a-3 and the sending/receiving portion 10a-2.

Next, step S210 will be described. When information of telephone number of a sending destination (communication unit 20-3) is given, a mating party (sending destination) is specified by the communication information estimating portion 10b-1 and information of the mating party 405 and the on-communication terminal 403 of the communication information temporary storage portion 10f-2 is updated. On the other hand, if no mating party can be specified, it is specified as a unknown mating party and the processing is terminated. On the communication information estimating portion 10b-2 of the communication unit selecting apparatus 10-2 also, a mating party (sender) is specified based on information given by the communication unit 20-3 and the on-communication terminal 403 and the mating party 405 of the communication information temporary storage portion 10f-2 is updated.

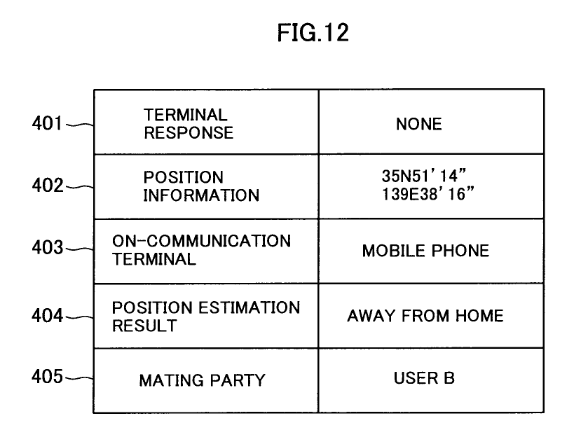

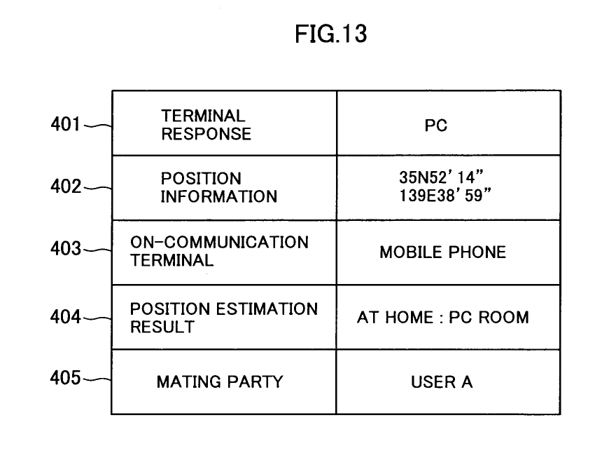

Because information stored in the permission information storage portion 10e-1 in the communication unit selecting apparatus 10-1 is as shown in FIG. 3, if a telephone number of a mating party (sending destination) given by the communication unit 20-1 is “090-3333-3333”, the mating party (sending destination) of the communication unit 20-1 is determined to be “user B” so that as shown in FIG. 12, the mating party 405 is updated to the value “user B”. Further, because the communication unit 20-1 is a mobile phone, the on-communication terminal 403 is updated to the value “mobile phone” as shown in FIG. 12 by the communication information estimating portion 10b-1. On the other hand, because information stored in the permission information storage portion 10e-2 in the communication unit selecting apparatus 10-2 is as shown in FIG. 8, if the telephone number of a mating party (sender) given by the communication unit 20-2 is “090-5555-5555”, the mating party (sender) of the communication unit 20-2 can be determined to be “user A”, so that as shown in FIG. 13, the mating party 405 is updated to the value “user A”. Further, because the communication unit 20-2 is a mobile phone, the on-communication terminal 403 is updated to the value “mobile phone” by the communication information estimating portion 10b-2.

Next, step S220 will be described. In this step S220, information of the publication permission 306 of the permission information storage portion 10e-1 is referred to in the communication information estimating portion 10b-1 so as to determine whether or not it is possible to acquire a status of the mating party (user B) of the communication unit 20-1. If information of the publication permission 306 of a corresponding mating party 301 is “OK”, it is determined that the status of the mating party (user B) can be acquired and the procedure proceeds to next step S225. If the information is “NG”, it is determined that the status of the mating party (user B) cannot be acquired and the processing is terminated. In the communication information estimating portion 10b-2 of the communication unit selecting apparatus 10-2 also, whether or not the status of the mating party (user A) of the communication unit 20-3 can be acquired is determined.

In the information stored in the permission information storage portion 10e-1 of the communication unit selecting apparatus 10-1, the publication permission 306 of the mating party (user B) is “OK” as shown in FIG. 3. Thus, it is determined that the status of the mating party (user B) can be acquired in the communication information estimating portion 10b-1 and then the procedure proceeds to next step S225. Further, it is determined that the status of the mating party (user A) can be acquired in the communication information estimating portion 10b-2 of the communication unit selecting apparatus 10-2 and the procedure proceeds to next step S225.

Next, step S225 will be described. In this step S225, in the communication information estimating portion 10b (10b-1, 10b-2), the values of the on-communication terminal 403 and the mating party 405 of the communication information temporary storage portion 10f (10f-1, 10f-2) are referred to and if those values are cleared, it is determined that communication is terminated and the processing is terminated. If they are not cleared, the procedure proceeds to next step S230.

Information stored in the communication information temporary storage portion 10f-1 is as shown in FIG. 12 such that the on-communication terminal 403 and the mating party 405 are not cleared. Information stored in the communication information temporary storage portion 10f-2 is not cleared as shown in FIG. 13. Consequently, the communication unit selecting apparatuss 10-1, 10-2 proceeds to next step S230.

Next, step S230 will be described. In this step S230, which a current position of user of the given unit is at home or away from home is determined by the communication information estimating portion 10b (10b-1, 10b-2) and information of the position estimation result 404 of the communication information temporary storage portion 10f (10f-1, 10f-2) is updated and then, the procedure proceeds to next step S240.

If it is assumed that the current position of user A is determined to be away from home based on information of the position information 402 of the communication information temporary storage portion 10f-1 in the communication information estimating portion 10b-1, information of the position estimation result 404 is updated to “away from home” as shown in FIG. 12. On the other hand, if it is assumed that the current position of user B is determined to be “at home” in the communication information estimating portion 10b-2, information of the position estimation result 404 is updated to “at home”.

Next, step S240 will be described. In this step S240, if it is determined that the current position of user of the given unit is “at home” in step S230, where at home the user exists is estimated by the communication information estimating portion 10b (10b-1, 10b-2) is estimated and then information of the position estimation result 404 of the communication information temporary storage portion 10f is updated. A signal saying that the operation of communication information estimation is completed is given to the recommendation determining portion 10d (10d-1, 10d-2) and the procedure proceeds to next step S250. If it is determined that the current position of user of the given unit is “away from home” in step S230, nothing is done at step S240 and the procedure proceeds to next step S250.

Because in the above step S230, it is determined that the current position of the user of the given unit is “at home” by the communication unit selecting apparatus 10-2 used by the user B alone, the aforementioned updating is performed by only the communication unit selecting apparatus 10-2. If information of the terminal response 401 stored in the communication information estimating portion 10b-2 is “PC” as shown in FIG. 13, it is determined that user B of the communication unit selecting apparatus 10-2 is operating the PC in the communication information estimating portion 10b-2. The installation position 503 of the PC stored in the terminal information storage portion 10g-1 of the communication unit selecting apparatus 10-2 is “at home: PC room” as shown in FIG. 9. Thus, it is determined that the current position of user B of the communication unit selecting apparatus 10-2 is PC room at home by the communication information estimating portion 10b-2, the information of the position estimation result 404 of the communication information temporary storage portion 10f-2 is updated from “at home” to “at home: PC room” as shown in FIG. 13.

Next, step S250 will be described. In this step S250, if a signal saying that the operation of the communication information estimation is completed, an available communication unit is extracted by the status analyzing portion 10c (10c-1, 10c-2).

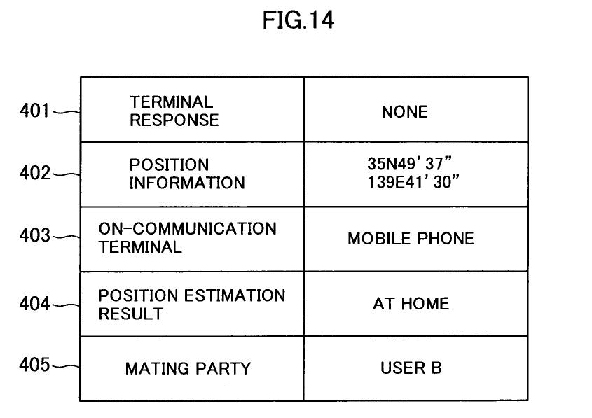

Information of the position estimation result 404 stored in the communication information temporary storage portion 10f-1 of the communication unit selecting apparatus 10-1 used by user A is “away from home” as shown in FIG. 12 and the communication unit 20 in which information of the moving range 504 stored in the terminal information storage portion 10g-1 is “away from home” is only “mobile phone” as shown in FIG. 5 and thus, the “mobile phone” is extracted as an available communication unit” by the status analyzing portion 10c-1. After that, if user A gets home and information of the position estimation result 404 of the communication information temporary storage portion 10f-1 is updated to “at home” as shown in FIG. 14, the “PC” and “mobile phone” are extracted as available communication units” by the status analyzing portion 10c-1 because the communication unit 20 in which information of the moving range 504 stored in the terminal information storage portion 10g-1 is “at home” is “PC” and “mobile phone” as shown in FIG. 5.

Information of the position estimation result 404 stored in the communication information temporary storage portion 10f-2 of the communication unit selecting apparatus 10-2 used by user B is “at home: PC room” as shown in FIG. 13 and the communication unit 20 in which information of the moving range 504 stored in the terminal information storage portion 10g-2 is “at home: PC room” is “PC” and “mobile phone” as shown in FIG. 9. Consequently, the “PC” and “mobile phone” are extracted as available communication units by the status analyzing portion 10c-2. In processings up to step S250, the same operations are carried out in the communication unit 20 and communication unit selecting apparatus 10 on sender side, and the communication unit 20 and the communication unit selecting apparatus 10 on receiving side.

Next, step S260 will be described. In this step S260, which a given unit exists on sender side or on receiving side is determined by the status analyzing portion 10c (10c-1, 10c-2) and if it is determined to exist on the sender side, the procedure is started from step S270 described later and if it is determined to exist on the receiving side, the procedure is started from step S265 described later. Here, as described above, the communication unit selecting apparatus 10-1 acts as the sender side while the communication unit selecting apparatus 10-2 acts as the receiving side.

Next, step S270 will be described. If it is determined that the given unit is a unit on the sender side by the status analyzing portion 10c-1 as a determination of step S260, information of the permission information storage portion 10e-1 is referred by the status analyzing portion 10c so as to acquire information of the server address 302 of user B who is a mating party. Then, the status analyzing portion 10c-1 communicates with the communication unit selecting apparatus 10-2 on the receiving side through the sending/receiving portion 10a-1 and the network 30 so as to request for information about the priority of an available communication unit in the communication unit selecting apparatus 10-2 and the communication unit 20 (priority order 502 of the terminal information storage portion 10g-2). Then, information about the priority of an available communication unit in the communication unit selecting apparatus 10-2 on the receiving side and the communication unit 20 (priority order 502 of the terminal information storage portion 10g-2) is acquired by response processing to step S270 in S265 (described later) in the receiving side (communication unit selecting apparatus 10-2).

Next, step S280 will be described. In this step S280, when information of an available communication unit is given by the communication unit selecting apparatus 10-2, the available communication unit in the communication unit selecting apparatus 10-2 is compared with the available communication unit in the given unit (communication unit selecting apparatus 10-1) extracted in step S250 by the status analyzing portion 10c-1 so as to determine whether or not any communication unit 20 coincident in terms of the kind exists. If it is determined that no communication unit 20 coincident in terms of the kind exists, the procedure proceeds to step S310, and the communication unit selecting apparatus 10-1 is started from step S225 after it stands by in a specified time. On the other hand, if it is determined that a communication unit 20 coincident in terms of the kind exists, information acquired from the communication unit selecting apparatus 10-2 is given from the status analyzing portion 10c-1 to the recommendation determining portion 10d-1 and the procedure proceeds to next step S290.

Because the available communication units under the communication unit selecting apparatus 10-1, 10-2 are “PC” and “mobile phone” and a result that the available communication units are coincident is reached, the procedure proceeds to step S290.

Next, step S290 will be described. In this step S290, if information acquired from the communication unit selecting apparatus 10-2 is given, whether or not a communication unit 20 having a higher priority than the communication unit 20 used currently for communication of the communication units 20 coincident with that under the communication unit selecting apparatus 10-2 exists on both the sender side (communication unit selecting apparatus 10-1) and the receiving side (communication unit selecting apparatus 10-2) as an available communication unit and the kinds of the corresponding communication units are coincident is determined by the recommendation determining portion 10d-1. If it is determined that the corresponding communication units 20 exists as a result of the determination in the recommendation determining portion 10d-1, the procedure proceeds to next step S300. On the other hand, if it is determined that no corresponding communication unit 20 exists, the procedure proceeds to step S310 and after standing by for a specified time (S310), the procedure is started from step S225.

In the information stored in the communication information temporary storage portion 10f-1, as shown in FIG. 14, the communication unit 20 (on-communication terminal 403) used currently by user A for communication with user B is “mobile phone”. Further, because the “PC” and “mobile phone” are extracted as the available communication unit here and the information of the terminal information storage portion 10g-1 is as shown in FIG. 5, the available communication unit having a higher priority than the “mobile phone” used currently for communication is “PC” alone. In the communication unit selecting apparatus 10-2 also, the same determination is made by the recommendation determining portion 10d-1 based on information acquired from the communication unit selecting apparatus 10-2, so that it is determined that the available communication unit having a higher priority than the “mobile phone” used currently for communication is “PC” alone. Thus the corresponding communication units 20 on both the sender side (communication unit selecting apparatus 10-1) and the receiving side (communication unit selecting apparatus 10-2) are coincident as “PC” and the procedure proceeds to next step.

Next, step S300 will be described. In this step S300, the communication unit 20 (PC) extracted in step S290 is recommended to user A as a communication unit optimum for communication with user B by a predetermined recommending means possessed by the recommendation determining portion 10d-1. As its specific example, for example, this is executed when the recommendation determining portion 10d-1 on the sender side sends a signal having such a meaning (for example, mail or predetermined special sound) to the communication unit 20 used for communication currently by a receiver.

In step S310, the communication unit selecting apparatus 10-1 stands by for a specified time and repeats the same procedure from step S225.

Next, step S265 will be described. If it is determined that the given unit is a unit on the receiving side by the communication information estimating portion 10b-2 of the communication unit selecting apparatus 10-2 based on a determination of the step S260, the procedure is held until the sender side (communication unit selecting apparatus 10-1) requests for information of the available communication unit on step S270. Then, as a response (answer) to the request from the sender side (communication unit selecting apparatus 10-1), information about the available communication unit under the communication unit selecting apparatus 10-2 and the priority of that communication unit 20 (priority order 502 of the terminal information storage portion 10g-2) is given and the procedure returns to step S225.

### (A-3) Effect of First Embodiment

According to the first embodiment, even on communication, an optimum communication unit 20 can be recommended by considering a behavior range upon using each communication unit corresponding to changes in the position information 402 of the communication information temporary storage portion 10f which changes during a communication, that is, the current location of user of the communication unit selecting apparatus 10 so as to secure an effective communication with the mating party even in a long hour communication.

### (B) Second Embodiment

Hereinafter, the communication unit selecting apparatus, communication unit selecting system and communication unit selecting program of the second embodiment will be described with reference to the drawings.

### (B-1) Configuration of the Second Embodiment

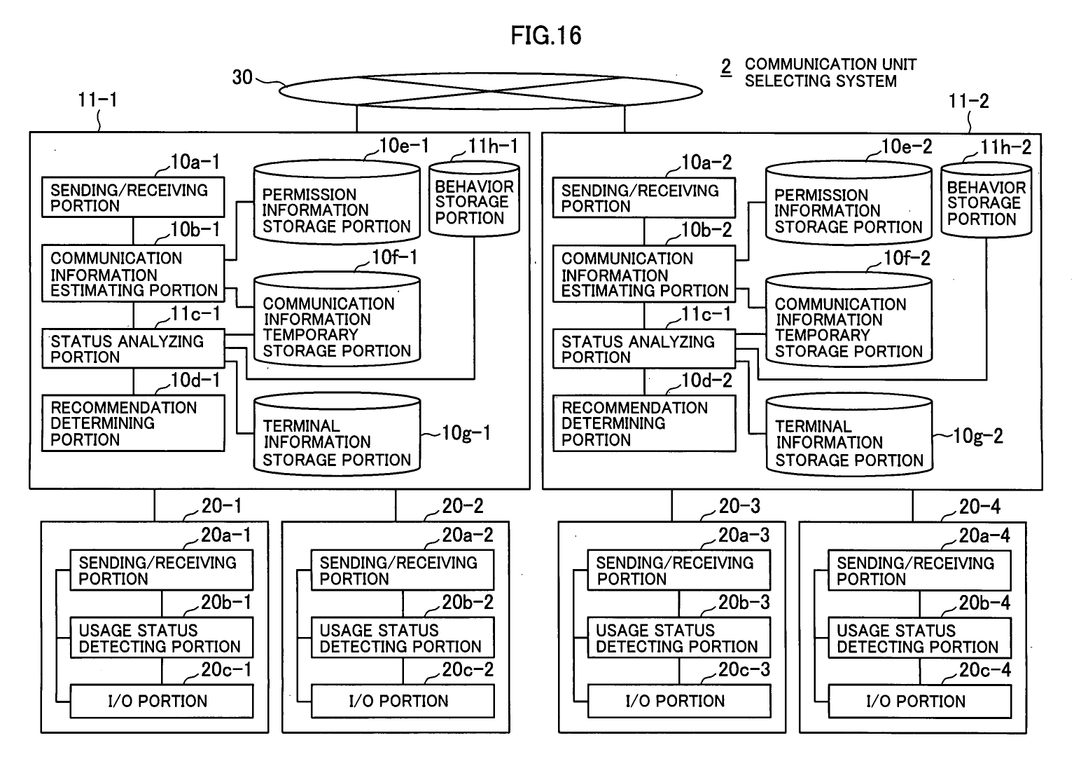

FIG. 16 is a block diagram showing the entire configuration of the communication means selecting system of this embodiment and like and corresponding reference numerals are attached to the same as and corresponding portions to FIG. 1 mentioned above.

The communication unit selecting system 2 includes a plurality of the communication unit selecting apparatus 11 (11-1, 11-2, . . . ), a plurality of the communication units 20 (20-1, 20-2, 20-3, 20-4, . . . ) and the network 30. Hereinafter, a difference in configuration between the communication unit selecting system 1 of the first embodiment and the communication unit selecting system 2 of the second embodiment will be described.

In the communication unit selecting apparatus 11 of the second embodiment, a behavior storage portion 11h is added to the communication unit selecting apparatus 10 of the first embodiment and the status analyzing portion 10c is replaced with a status analyzing portion 11c.

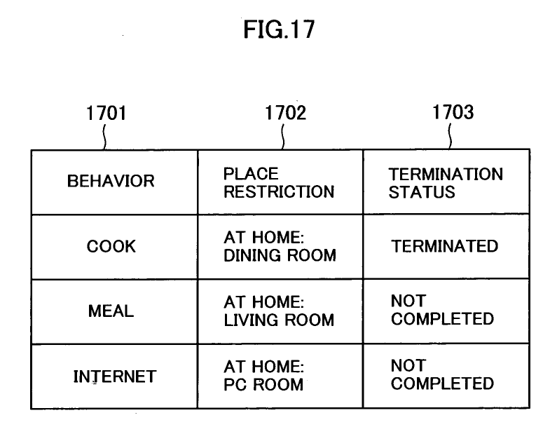

FIG. 17 is an explanatory diagram showing the configuration of information stored in the behavior storage portion 11h. The behavior storage portion 11h stores a behavior schedule of user of a given unit and possesses information about behavior 1701, place restriction 1702 and termination status 1703.

The behavior 1701 stores names of the behavior schedule such as “cook”, “meal” and “Internet” as shown in FIG. 17. The place restriction 1702 stores information of place restriction corresponding to the behavior 1701. The information to be stored in the place restriction 1702 may be of the same style as the position estimation result 404 of the communication information temporary storage portion 10f, and for example, information such as “at home: dining room”, “at home: living room” and “at home: PC room” is stored as shown in FIG. 17.

The termination status 1703 stores information about whether or not the corresponding behavior is terminated and for example, if the corresponding behavior 1701 is terminated, it may be stored as “terminated” and otherwise, it may be stored as “not terminated” as shown in FIG. 17.

Although the status analyzing portion 10c of the first embodiment extracts a communication unit 20 which can be used currently by user of a given unit as the available communication unit by referring to information of the communication information temporary storage portion 10f and the terminal information storage portion 10g, the status analyzing portion 11c of the second embodiment is different from the status analyzing portion 11c in that it extracts the communication unit 20 which can be used by the user of the given unit in the future as well as now as the available communication unit based on information of the behavior storage portion 11h.

As an extraction method of the available communication unit in the status analyzing portion 11c, it is permissible to erase a communication unit 20 which is affected by a current behavior of the user of the given unit from the available communication units based on information of the behavior storage portion 11h.

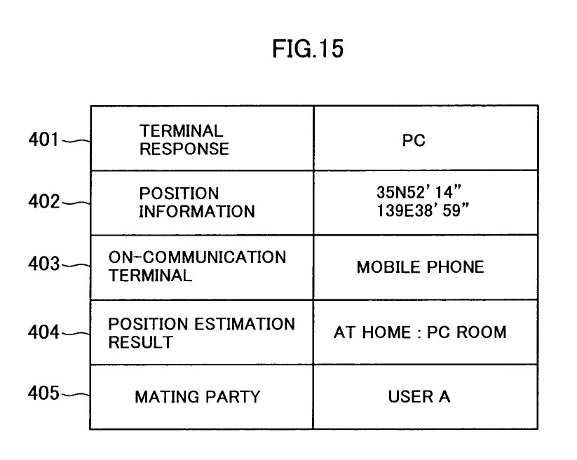

For example, it is assumed that information of the position estimation result 404 of the communication information temporary storage portion 10f-2 in the communication unit selecting apparatus 11-2 used by user B is “at home: PC room” as shown in FIG. 15 and the communication unit 20 currently available in “at home: PC room” based on the information of the terminal information storage portion 10g-2 is “PC” and “mobile phone”. Further, according to the information stored in the terminal information storage portion 10g-2, it is assumed that as shown in FIG. 9, the moving range 504 of the terminal name 501 “PC” is “at home: PC room” and the PC cannot be used anywhere except the PC room. If it is assumed that the information shown in FIG. 17 is stored in the behavior storage portion 11h-2, the behavior 1701 when the termination status 1703 is “not completed” includes “meal” and “Internet” and the place restriction 1702 of the “meal” falls under “at home: living” and because the PC cannot be used anywhere except the PC room, the “PC” is erased from the available communication unit and then the available communication terminal extracted by the status analyzing portion 11c-2 is “mobile phone” only.

If the termination status 1703 when the behavior 1701 is “meal” is updated to “terminated” in the behavior storage portion 11h-2 with a passage of time, the extraction of the available communication unit is carried out as follows. In this case, the behavior 1701 when the termination status 1703 is “not completed” is “Internet” only in the behavior storage portion 11h-2, the place restriction 1702 of the “Internet” is “at home: PC room” as shown in FIG. 17. Because the information stored in the terminal information storage portion 10g-2 is as shown in FIG. 9, it can be determined that the communication unit 20 available in the “at home: PC room” is “PC” and “mobile phone” and neither the “PC” nor “mobile phone” is erased from the available communication unit.

The status analyzing portion 11c updates information of the behavior storage portion 11h. For example, it is permissible to store a behavior termination time of the behavior 1701 in the behavior storage portion 11h and determine which behavior is terminated depending on a current time so as to update the termination status 1703. Further, it is permissible to dispose an infrared ray sensor in a house and monitor the behavior of user to determine which behavior is terminated and update the information of the termination status 1703. The information of the behavior storage portion 11h may be updated manually by user.

### (B-2) Operation of the Second Embodiment

The operation of the communication unit 20 in the communication unit selecting system 2 can be represented with substantially the same flow chart as FIG. 7 mentioned above. Although not shown, in step S255 between step S250 and step S260 in FIG. 7, the communication unit 20 which is affected by a future behavior of user of the given unit is erased from the available communication units in the status analyzing portion 11c and other operations is the same as the first embodiment. In step S255, the status analyzing portion 11c erases the communication unit 20 which is affected by a future behavior of user of the given unit form the available communication units extracted in step S250 based on the information of the behavior storage portion 11h and the communication units 20 after the erase are handled as available communication units in subsequent steps.

### (B-3) Effect of the Second Embodiment

Although the first embodiment enables an optimum communication unit to be recommended corresponding to a current status of user of the communication unit selecting apparatus 10, a future schedule of the user is not taken into account. Thus, even if user is scheduled to make a behavior which limits a work place for meal or the like after he or she gets home, a recommendation of changing the communication unit 20 by mistake may be made. If the user is scheduled to go out even after he or she gets home temporarily, when he or she talks with a mobile phone, it is not necessary to change this status. Because the communication unit selecting system 1 of the second embodiment manages the future schedule of the user of the given unit by providing with the behavior storage portion 11h, the optimum communication unit 20 can be selected and recommended by taking into account the future schedule of the user.

### (C) Other Embodiments

The present invention is not restricted to the above-described embodiments but modified embodiments exemplified below may be picked up.

(C-1) Although in the first embodiment, only when the available communication unit on the sender side (communication unit selecting apparatus 10-1) and the available communication unit on the receiving side (communication unit selecting apparatus 10-2) are coincident in terms of the kind, the optimum communication unit 20 is selected and recommended to user, the optimum communication unit 20 may be selected even if the kinds are not coincident. For example, because a call can be made from a mobile phone to a fixed-line phone, the available communication units do not always need to coincide with each other on the sender side and on the receiving side. At this time, a combination which costs lowest for communication cost may be selected as the optimum communication unit 20.
(C-2) According to the first embodiment, the communication information estimating portion 10b obtains the position estimation result 404 of the communication information temporary storage portion 10f based on the latitude/longitude information stored in the position information 402. If the communication unit 20 cannot communicate, the current location of user of the given unit may be estimated to be “away from home”. For example in case where the communication unit 20 is a mobile phone, even when it cannot communicate with the communication unit selecting apparatus 10, it can be estimated to be “away from home” even if the position information of that user cannot be acquired.
(C-3) Although in each of the above-described embodiments, the sender side and receiving side have different communication unit selecting apparatus 10, they may be replaced with a single one.
(C-4) Although in each of the above-described embodiments, the communication unit selecting apparatus 10, 11 is constructed by installing the communication unit selecting program of the above-described embodiments in an information processing unit such as a personal computer, it is permissible to install the communication unit selecting program of the above-described embodiments in an exchange unit having a program executing configuration such as CPU and use this exchange unit instead. The exchange unit includes for example, an exchange unit for mobile phone network and PBX.
(C-5) Although in the first embodiment, the communication information estimating portion 10b estimates a location of user in home based on information such as keyboard operation of the communication unit 20, it is permissible to dispose infrared ray sensors or cameras every where in a house and estimate the location of user based on information acquired therefrom. The estimation method is not limited to any particular one.
(C-6) Although in the first embodiment, if the position estimation result 404 in the communication information temporary storage portion 10f is “away from home”, no further detailed estimation about the location is made, it is permissible to register the latitude/longitude of a particular place and estimate where the user exists away from home by comparing it with information of the position information 402 to select the communication unit 20 based on that information. Because the same mobile phones might have different communicable ranges depending on the kinds, the optimum communication unit 20 can be selected in such a case also.
(C-7) Although in the first embodiment, the communication unit 20 has only a single communication means, it may have a plurality of the communication means and the communication unit selecting apparatus 10 may recommend an optimum communication unit 20 by specifying its communication means as well. For example, in case of a mobile phone terminal having a communication means by wireless LAN, which communication by telephone network or communication by wireless LAN is optimum is also selected and recommended.
(C-8) Although in each of the above-described embodiments, the communication unit selecting apparatus 1, 2 selects and recommends the optimum communication unit 20 for only audio communication, the present invention is not restricted to the audio communication but any type of communication means such as chat of keeping communication through character input or TV telephone may be used as long as communication is enabled between mating users.
(C-9) Although according to the second embodiment, the behavior storage portion 11h is provided on both the communication unit selecting apparatus 11 on the sender side and receiving side and an available communication unit is extracted by the status analyzing portion 11c based on that information, it is permissible to use the communication unit 11 on only one of the sender side and receiving side and replace the other one with the communication unit selecting apparatus 10 of the first embodiment.
(C-10) Although in each of the above-described embodiments, the communication unit selecting apparatus 10, 11 specifies a communication unit 20 having the highest priority from available communication units and recommend it to user, a plurality of the communication units may be recommended. For example, it is permissible to recommend all the available communication units or recommend the communication units up to the third highest priority. Further, it is permissible to notify information about all the available communication units and information about the communication unit 20 having the highest priority.

It should be understood by those skilled in the art that various modifications, combinations and sub-combinations and alterations may occur depending on design requirements and other factors insofar as they are within the scope of the appended claims or the equivalents thereof.

What is claimed is:

1. A communication unit selecting apparatus comprising:
an available communication unit extracting means which when user status information concerning the status of first user and second user is provided from outside during communication between a first communication unit used by the first user and a second communication unit used by the second user, extracts an available communication unit which is available for communication between the first user and the second user from preliminarily prepared candidates based on the user status information; and
a communication unit selecting means for selecting the extracted available communication unit as a communication unit suitable for communication between the first user and the second user.

2. The communication unit selecting apparatus according to claim 1 further comprising a communication unit recommending means for recommending a communication unit selected by the communication unit selecting means to at least one of the first user and the second user.

3. The communication unit selecting apparatus according to claim 2 wherein the communication unit recommending means provides the first communication unit or the second communication unit on communication of the recommended user with information of the communication unit selected by the communication unit selecting means.

4. The communication unit selecting apparatus according to claim 1 wherein the communication unit selecting means selects only a communication unit having the highest priority determined from a predetermined viewpoint from the available communication unit candidates.

5. The communication unit selecting apparatus according to claim 1 further comprising a user position estimating means for estimating the position of at least one of the first user and the second user, wherein information of a position estimated by the user position estimating means is contained as the user status information.

6. The communication unit selecting apparatus according to claim 5 wherein when the position information of at least one of the communication unit used by the first user and the communication unit used by the second user is provided from an external unit, the user position estimating means estimates the position of the first user or the second user corresponding to the communication unit concerned with the position information, based on the position information.

7. The communication unit selecting apparatus according to claim 1 further comprising a behavior schedule information storage means for storing behavior schedule information concerning the behavior schedule of at least one of the first user and the second user,
wherein the behavior schedule information is contained as the user status information.

8. A communication unit selecting system comprising:
the communication unit selecting apparatus according to claim 2; and
a recommended unit notifying means which when other communication unit suitable for communication between the first user and the second user is recommended by the communication unit selecting apparatus, notifies the recommended other communication unit to user of the communication unit.

9. The communication unit selecting system according to claim 8 wherein the communication unit further includes a user status information providing means for acquiring user status information concerning the status of user of a given communication unit and providing the acquired status to the communication unit selecting apparatus.

10. An exchange unit comprising the communication unit selecting apparatus according to claim 1.

11. A communication unit selecting program for selecting a communication unit for use in communication between the first user and the second user,
the communication unit selecting program making a computer function as an available communication unit extracting means which when user status information concerning the status of first user and second user is provided from outside during communication between a first communication unit used by the first user and a second communication unit used by the second user, extracts an available communication unit which is available for communication between the first user and the second user from preliminarily prepared candidates based on the user status information; and
a communication unit selecting means for selecting the extracted available communication unit as a communication unit suitable for communication between the first user and the second user.
